(19) United States
(12) Patent Application Publication
(10) Pub. No.: US 2024/0166199 A1
(43) Pub. Date: May 23, 2024

(54) BEHAVIOR PLANNING DEVICE, VEHICLE CONTROL SYSTEM, AND BEHAVIOR PLAN GENERATION METHOD

(71) Applicant: Mitsubishi Electric Corporation, Tokyo (JP)

(72) Inventors: Takayuki TANAKA, Tokyo (JP); Hiroshi YAMADA, Tokyo (JP); Nariaki TAKEHARA, Tokyo (JP); Toru HIGUCHI, Tokyo (JP)

(73) Assignee: Mitsubishi Electric Corporation, Tokyo (JP)

(21) Appl. No.: 18/378,704

(22) Filed: Oct. 11, 2023

(30) Foreign Application Priority Data
Nov. 21, 2022 (JP) 2022-185526

(51) Int. Cl. B60W 30/09; B60W 30/095; B60W 30/18; B60W 50/02; G06V 20/58; G08G 1/16

(52) U.S. Cl. CPC B60W 30/09; B60W 30/0953; B60W 30/0956; B60W 30/18154; B60W 50/0205; B60W 50/0225; G06V 20/58; G08G 1/16; B60W 2552/00; B60W 2556/50

(57) ABSTRACT

Provided is a behavior planning device, a vehicle control system, and a behavior plan generation method in which whether or not to immediately stop is determined at a time when abnormality has been detected, thus reducing obstruction of advancement of another traffic participant. This behavior planning device includes: a stop request determination unit which determines occurrence of abnormality on the basis of acquired obstacle information, own-position information, road information, and vehicle state information, and outputs an emergency stop request or a stop request; and a behavior plan generation unit which, in a case where the emergency stop request is outputted, generates a behavior plan for immediately stopping a mobile object, and in a case where the stop request is outputted, generates a behavior plan for preventing the mobile object from stopping in an area where advancement of another traffic participant is obstructed.

### BACKGROUND OF THE INVENTION

### 1. Field of the Invention

The present disclosure relates to a behavior planning device, a vehicle control system, and a behavior plan generation method.

### 2. Description of the Background Art

In recent years, automated driving technology for automobiles have been increasingly developed, and not only driving assistance for a user but also technology for performing automated driving without user's operation is attracting attention. In performing automated driving, in a case where traveling cannot be performed safely as in a case where some of sensors for detecting the surrounding environment around the own vehicle fail, it is required to stop the vehicle in a situation with a low accident risk without obstructing another traffic participant.

For example, in Patent Document 1, in a case where malfunction has occurred on a recognition device or the like and information for the outside environment cannot be acquired, a traveling trajectory is generated on the basis of outside environment information recognized in the past, thus shifting to a malfunction coping behavior.
Patent Document 1: Japanese Laid-Open Patent Publication No. 2016-38689

In Patent Document 1, if abnormality has occurred in a vehicle system during a process for shifting to the malfunction coping behavior, the shifting to the malfunction coping behavior might be interrupted. If the shifting to the malfunction coping behavior is interrupted in an area where roads intersect each other such as the inside of an intersection, advancement of another traffic participant is obstructed. Thus, there is a problem for making improvement in automated driving.

### SUMMARY OF THE INVENTION

The present disclosure has been made to solve the above problems, and an object of the present disclosure is to provide a behavior planning device, a vehicle control system, and a behavior plan generation method in which whether or not to immediately stop is determined at a time when abnormality has been detected, thus reducing obstruction of advancement of another traffic participant.

A behavior planning device according to the present disclosure is a behavior planning device which receives obstacle information around a mobile object acquired by an obstacle information acquisition unit, position information of the mobile object acquired by an own-position acquisition unit, road information around the mobile object acquired by a road information acquisition unit, obstacle information around a roadside acquired by a roadside information acquisition unit, and vehicle state information including a control state of the mobile object acquired by a vehicle state information acquisition unit, the behavior planning device including: a stop request determination unit which determines whether or not to output an emergency stop request for the mobile object, when having determined that abnormality has occurred for at least one of the obstacle information around the mobile object acquired by the obstacle information acquisition unit, the position information of the mobile object acquired by the own-position acquisition unit, the road information acquired by the road information acquisition unit, the obstacle information around the roadside acquired by the roadside information acquisition unit, and the vehicle state information acquired by the vehicle state information acquisition unit; and a behavior plan generation unit which generates a behavior plan for the mobile object.

The stop request determination unit, when having detected abnormality,
in a case where a predetermined output condition for the emergency stop request is satisfied, outputs the emergency stop request, and
in a case where the output condition is not satisfied, outputs a stop request.

The behavior plan generation unit
in a case where the emergency stop request is outputted from the stop request determination unit, generates a behavior plan for immediately stopping the mobile object, and
in a case where the stop request is outputted from the stop request determination unit, generates a behavior plan for preventing the mobile object from stopping in an area where advancement of another traffic participant is obstructed.

According to the present disclosure, whether or not to immediately stop is determined at a time when abnormality has been detected, whereby it becomes possible to generate such a behavior plan that reduces obstruction of advancement of another traffic participant.

### BRIEF DESCRIPTION OF THE DRAWINGS

FIG. 1 is a function block diagram showing the configurations of a behavior planning device and a vehicle control system according to the first embodiment of the present disclosure;

FIG. 2 shows an example of detection ranges for an obstacle by obstacle information detection units mounted to a vehicle;

FIG. 3 illustrates operation of the behavior planning device according to the first embodiment;

FIG. 4 is a flowchart showing operation in the behavior planning device according to the first embodiment;

FIG. 5A is a flowchart showing operation in a behavior planning device according to the second embodiment of the present disclosure;

FIG. 5B is a flowchart showing operation in the behavior planning device according to the second embodiment;

FIG. 6 illustrates operation in a behavior planning device according to the third embodiment of the present disclosure;

FIG. 7A is a flowchart showing operation in the behavior planning device according to the third embodiment;

FIG. 7B is a flowchart showing operation in the behavior planning device according to the third embodiment;

FIG. 8 shows a hardware configuration of the vehicle control system according to each of the first to third embodiments; and

FIG. 9 shows another example of a hardware configuration of the vehicle control system according to each of the first to third embodiments.

### DETAILED DESCRIPTION OF THE PREFERRED EMBODIMENTS OF THE INVENTION

Hereinafter, embodiments of a behavior planning device, a vehicle control system, and a behavior plan generation method according to the present disclosure will be described with reference to the drawings. In the following embodiments, an automobile is used as an example of a mobile object to which the behavior planning device and the vehicle control system are applied, and an example in which a behavior plan for the own vehicle is generated is shown. The mobile object is assumed to be capable of traveling by automated driving corresponding to level 3 or level 4 defined by Society of Automotive Engineers (SAE) International, for example. It is assumed that the mobile object has acquired a traveling route to a destination in advance and is traveling along the route. In the drawings, the same reference characters denote the same or corresponding parts. Therefore, the detailed description thereof may be omitted to avoid repeating the description.

The drawings are shown in a schematic way, and for convenience of description, some components are omitted or simplified as appropriate. The mutual relationship of sizes and positions of components and the like shown in different drawings are not necessarily shown precisely, and may be changed as appropriate. Also in drawings such as a plan view other than a sectional view, hatching may be applied for facilitating the understanding of contents of the embodiments.

### First Embodiment

Hereinafter, a behavior planning device, a vehicle control system, and a behavior plan generation method according to the first embodiment of the present disclosure will be described with reference to the drawings.

<Device Configuration>

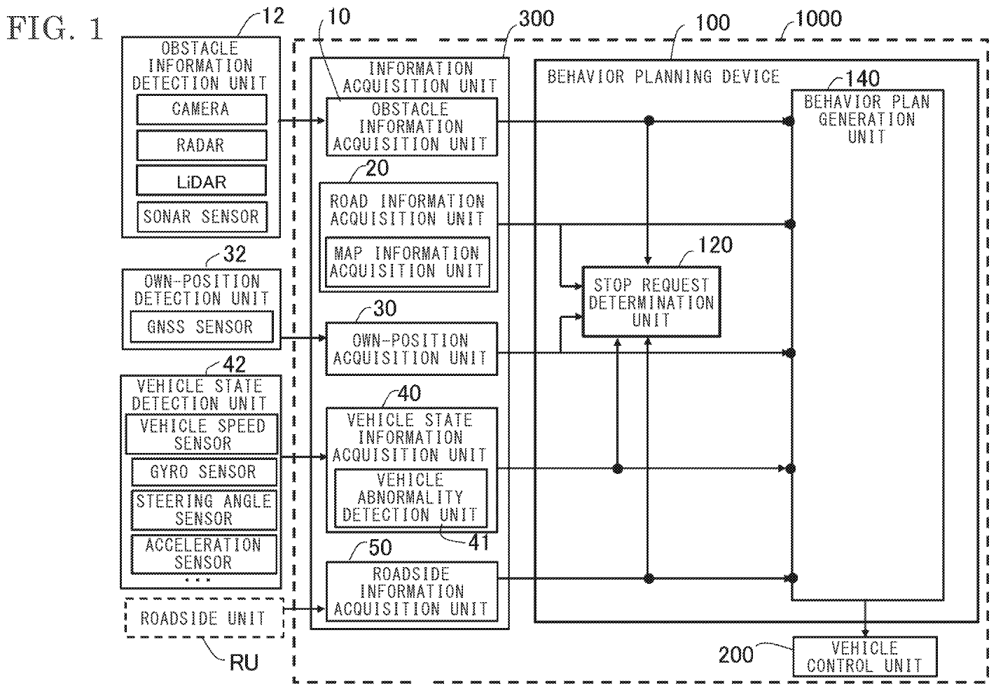

FIG. 1 is a function block diagram showing the configurations of the behavior planning device and the vehicle control system according to the first embodiment. In FIG. 1, a vehicle control system 1000 includes a behavior planning device 100. The behavior planning device 100 is a device for planning a behavior of the own vehicle, and includes a stop request determination unit 120 and a behavior plan generation unit 140 which performs calculation so as to generate such a behavior that reduces influence on the surroundings. The vehicle control system 1000 includes an information acquisition unit 300 which acquires information needed for generating a behavior plan for the own vehicle in the behavior planning device 100 and acquires obstacle information around the own vehicle. The information acquisition unit 300 includes an obstacle information acquisition unit 10, a road information acquisition unit 20, an own-position acquisition unit 30 which acquires position information of the own vehicle, a vehicle state information acquisition unit 40 which acquires information about the states of the own vehicle from sensors mounted to the vehicle, and a roadside information acquisition unit 50 which acquires information from a roadside unit RU. Further, the vehicle control system 1000 includes a vehicle control unit 200 and controls actuators for driving the vehicle, such as a brake and a steering wheel, on the basis of the behavior plan generated by the behavior planning device 100.

In FIG. 1, the obstacle information acquisition unit 10, the road information acquisition unit 20, the own-position acquisition unit 30, the vehicle state information acquisition unit 40, and the roadside information acquisition unit 50 may be included in the behavior planning device 100.

The obstacle information acquisition unit 10 acquires information of an obstacle present around the own vehicle, detected from an obstacle information detection unit 12.

The obstacle information detection unit 12 detects obstacle information. Obstacles are, for example, traffic participants such as another vehicle, a pedestrian, a bicycle, and a motorcycle present around the own vehicle. The obstacle information detection unit 12 is at least one of a camera, a radar, a light detection and ranging (LiDAR) device, and a sonar sensor (ultrasonic sensor) provided to the own vehicle, for example. The obstacle information detection unit 12 may output, to the obstacle information acquisition unit 10, obstacle information in which an obstacle present around the own vehicle is associated with the type of the traffic participant classified into another vehicle, a pedestrian, a bicycle, a motorcycle, or the like.

The cameras are provided at such positions that the cameras can take images in frontward, lateral, and rearward directions from the own vehicle. From the taken images, information indicating the environment around the vehicle, such as information of obstacles and lanes frontward of the own vehicle, is acquired.

The radar radiates a radar wave frontward of the own vehicle and detects a reflected wave thereof, thereby measuring a relative distance and a relative speed of an obstacle present frontward of the own vehicle, and outputs the measurement result.

The LiDAR device radiates a laser beam to an area around the own vehicle and detects a time difference until the laser beam is reflected and returns from a surrounding object, thereby detecting the position of the object.

The sonar sensor radiates an ultrasonic wave to an area around the own vehicle and detects a time difference until the ultrasonic wave is reflected and returns from a surrounding object, thereby detecting the position and the distance at which the object is present.

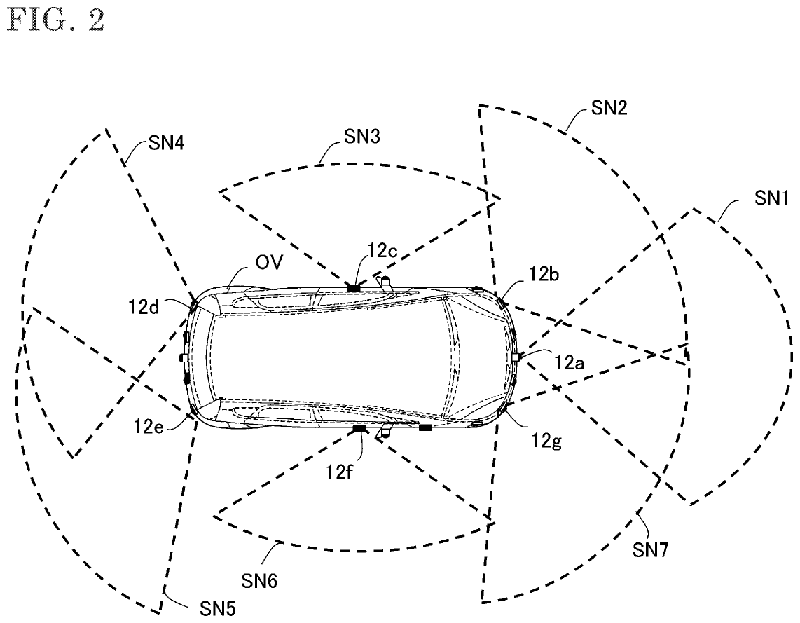

FIG. 2 shows an example in which a plurality of the obstacle information detection units 12 described above are combined and provided to the vehicle, and shows detection ranges of the respective obstacle information detection units 12. In FIG. 2, seven obstacle information detection units 12, i.e., obstacle information detection units 12a to 12g, are mounted to the own vehicle OV, three obstacle information detection units 12a, 12b, 12g are located on the front side, two obstacle information detection units 12c, 12f are located on the lateral sides, and two obstacle information detection units 12d, 12e are located on the rear side. The detection ranges of the respective obstacle information detection units 12 are shown by sector-shaped broken lines. The own vehicle OV can detect obstacles in detection ranges SN1, SN2, SN7 in the frontward area, detection ranges SN3, SN6 in the lateral areas, and detection ranges SN4, SN5 in the rearward area. The number of the obstacle information detection units 12 is not limited to seven. However, it is desirable that the detection ranges for obstacles can be set so as to cover the whole surrounding area around the own vehicle OV.

The road information acquisition unit 20 acquires information of roads around the own vehicle from a road information detection unit (not shown).

The road information acquisition unit 20 includes a map information acquisition unit which has acquired map data of a planned traveling route for the own vehicle in advance, and acquires road information around the own vehicle on the basis of own-vehicle position information detected by an own-position detection unit 32.

Here, the map data includes road information made up of center lines of lanes on which the own vehicle travels, lane widths, stop lines of intersections, the numbers of branches of intersections such as a T junction and a crossroad, stop lines of intersections, and diverging start positions.

Road information to be included in the map data may be acquired from a surrounding structure detection result obtained from at least one of the camera, the radar, the LiDAR device, and the sonar sensor which are the obstacle information detection units 12 provided to the own vehicle.

The own vehicle is provided with a global navigation satellite system (GNSS) sensor as the own-position detection unit 32, in order to identify the position of the own vehicle. A GNSS antenna is connected to the GNSS sensor, and a positioning signal from a positioning satellite moving along a satellite orbit is received by the GNSS antenna. The received positioning signal is analyzed and information of the phase center of the GNSS antenna (such as latitude, longitude, altitude, and orientation) is outputted to the own-position acquisition unit 30.

The own position which is position information of the own vehicle may be acquired by, instead of the method using the GNSS sensor, simultaneous localization and mapping (SLAM) (simultaneous execution of own-position estimation and environment map generation) technology using a surrounding structure detection result acquired from at least one of the camera, the radar, the LiDAR device, and the sonar sensor.

For example, an obstacle information detection device (hereinafter, referred to as roadside unit) provided in a roadside area includes at least one of a camera, a radar, a LiDAR device, and a sonar sensor. The roadside information acquisition unit 50 acquires information around the roadside detected by the roadside unit RU, as obstacle information, via wireless communication. As well as in a roadside area, the roadside unit may be provided at a road such as a lane, a road shoulder, or a pavement, or may be provided to a building, a utility pole, or the like near a road. In addition, information around the roadside may be acquired from a remote traffic control system or the like.

The vehicle state information acquisition unit 40 acquires vehicle states on the basis of a vehicle state of the own vehicle detected by a vehicle state detection unit 42 and abnormality detection from a vehicle abnormality detection unit 41. The vehicle state detection unit 42 detects a vehicle state from sensors mounted to the own vehicle, such as a vehicle speed sensor, a gyro sensor, a steering angle sensor, and an acceleration sensor.

Here, the vehicle abnormality detection unit 41 detects abnormality that hampers traveling of the vehicle, e.g., abnormality of an actuator such as a steering, a brake, or a drive motor of the vehicle, or abnormality of a power supply system.

In FIG. 1, the obstacle information acquisition unit 10, the road information acquisition unit 20, the own-position acquisition unit 30, the vehicle state information acquisition unit 40, and the roadside information acquisition unit 50 are shown so as not to be included in the behavior planning device 100. This configuration is suitable for remote control for the own vehicle by traffic control. As an example, a configuration including the stop request determination unit 120 and the behavior plan generation unit 140, and a configuration including the obstacle information acquisition unit 10, the road information acquisition unit 20, the own-position acquisition unit 30, the vehicle state information acquisition unit 40, and the roadside information acquisition unit 50, are provided separately from each other. Specifically, the obstacle information acquisition unit 10, the road information acquisition unit 20, the own-position acquisition unit 30, the vehicle state information acquisition unit 40, and the roadside information acquisition unit 50 are provided in the own vehicle, and the stop request determination unit 120 and the behavior plan generation unit 140 are provided on the traffic control side, as the behavior planning device 100. Without limitation thereto, the configurations may be reverse to each other, for example.

<Functions of Behavior Planning Device 100>

The stop request determination unit 120 detects abnormality on the basis of the obstacle information acquired from the obstacle information acquisition unit 10, the obstacle information acquired from the roadside information acquisition unit 50, the own-position information acquired from the own-position acquisition unit 30, and the state information of the own vehicle acquired from the vehicle state information acquisition unit 40. When having detected abnormality, the stop request determination unit 120 outputs an emergency stop request or a stop request for stopping at a position where the surroundings are less influenced.

Here, an example of a method for detecting abnormality that has occurred for obstacle information will be described.

First, an example about abnormality for obstacle information acquired from the roadside information acquisition unit 50 will be described. As abnormality for obstacle information acquired from the roadside information acquisition unit 50, there is communication disruption. Whether or not communication disruption has occurred can be determined by providing a signal counted up per certain cycle from a roadside unit to the roadside information acquisition unit 50. The reason is that, if an event in which count-up per certain cycle is not done is detected, this can be considered to mean that communication from the roadside unit RU to the roadside information acquisition unit 50 is disrupted. In this way, the stop request determination unit 120 determines communication disruption on the basis of obstacle information acquired from the roadside information acquisition unit 50, thus detecting abnormality.

Similarly, also regarding abnormality for the obstacle information acquired from the obstacle information detection unit 12 provided to the own vehicle, abnormality for own-position information acquired from the own-position acquisition unit 30, and abnormality for state information of the own vehicle acquired from the vehicle state information acquisition unit 40, communication disruption can be determined by using a signal counted up per certain cycle, whereby abnormality can be detected.

It is also assumed that the detection range of the obstacle information detection unit 12 is reduced. Regarding whether or not the detection range is reduced, snow or the like may be adhered around the sensor which is the obstacle information detection unit 12, and the detection range reduction can be determined by confirming whether or not a state in which the measurement distance is not greater than a predetermined threshold has been detected for a predetermined period. That is, in a case where snow or the like is adhered so as to cover a part of the sensor, the detection range is reduced as compared to the normal range, and thus abnormality can be detected. As another example, it is assumed that some of imaging elements of the camera fail, so that some pixels of the camera image have no colors or have not changed in colors for a predetermined period. Thus, the detection range is reduced and abnormality can be detected.

Next, a condition for outputting an emergency stop request or a stop request for stopping at a position where surroundings are less influenced will be described.

First, when abnormality has occurred, in a case of not corresponding to an output condition for an emergency stop request, a stop request for stopping at a position where the surroundings are less influenced (hereinafter, referred to as “stop request”) is outputted.

Output conditions for an emergency stop request are the following two cases.
(1) The first case is a case where the own vehicle cannot be prevented from stopping in an area where another traffic participant is greatly influenced even if the own vehicle continues traveling by automated driving, when abnormality has occurred.

Specific examples are as follows:
(1a) Case where the vehicle abnormality detection unit 41 has detected such abnormality that the own vehicle cannot be controlled
(1b) Case where obstacle information frontward of the own vehicle cannot be detected from each sensor of the obstacle information detection unit 12 and the roadside unit RU and thus the obstacle information acquisition unit 10 and the roadside information acquisition unit 50 cannot acquire obstacle information
(1c) Case where bad weather has been detected
(1d) Case where the own vehicle cannot advance because there is an obstacle frontward (e.g., there is an obstacle in an intersection or at the exit of an intersection)

It is noted that weather can be acquired from a remote traffic control system which communicates with a mobile object, the roadside unit RU, or the obstacle information detection unit 12. A meteorological sensor may be provided to the vehicle.
(2) The second case is a case where another traffic participant is less influenced by the own vehicle even if the own vehicle stops at the present position, when abnormality has occurred at a part other than the road information acquisition unit 20 and the own-position acquisition unit 30.

Specific examples are as follows:
(2a) Case where it is determined that the own vehicle is in a stop permitted area acquired from the road information acquisition unit 20
(2b) Case where the own vehicle is in an area where a risk of colliding with a vehicle traveling on a crossing road is low (e.g., near the entrance or the exit of an intersection)
(2c) Case where the own vehicle is in an area where the road width is sufficiently great (e.g., area with a width that allows another vehicle to overtake).

Here, the area where another traffic participant is greatly influenced refers to an area where advancement of another traffic participant is obstructed when the own vehicle is stopped at the position, and specific examples thereof are an area on the inner side of stop lines of an intersection, a diverging start position on an expressway, and the like, i.e., an “area where roads intersect each other”. Hereinafter, the “area where another traffic participant is greatly influenced” is referred to as an “area where advancement of another traffic participant is obstructed”, and these are used as the same meaning. In addition, an “area where another traffic participant is less influenced” is referred to as an “area where advancement of another traffic participant is not obstructed”, and these are used as the same meaning.

The behavior plan generation unit 140 generates a behavior plan that the own vehicle should execute, in accordance with an emergency stop request or a stop request outputted from the stop request determination unit 120.

When an emergency stop request is inputted from the stop request determination unit 120, the behavior plan generation unit 140 generates a behavior plan for immediately stopping the own vehicle.

When a stop request is inputted, the behavior plan generation unit 140 generates a behavior plan for preventing the own vehicle from stopping in an area where advancement of another traffic participant is obstructed, on the basis of the obstacle information outputted from the obstacle information acquisition unit 10, the road information outputted from the road information acquisition unit 20, the own position outputted from the own-position acquisition unit 30, and the obstacle information outputted from the roadside information acquisition unit 50.

Specifically, the behavior plan for the own vehicle generated by the behavior plan generation unit 140 includes a target route, a target speed, and a target position for the own vehicle to travel while following them as targets. In addition, the behavior plan may include information indicating upper and lower limits of the acceleration for the own vehicle to travel and the steering angle for following the target route.

Next, in the behavior plan generation unit 140, for generating a behavior plan for preventing the own vehicle from stopping in an area where advancement of another traffic participant is obstructed, a method for calculating the stop position of the own vehicle first will be described.

Here, as a method for calculating the stop position, the present position may be calculated directly as the stop position, or the stop position may be calculated using a deceleration that can be produced by the own vehicle in a case of stopping from the present vehicle speed, for example.

Whether or not the calculated stop position of the own vehicle is in an area where advancement of another traffic participant is obstructed is determined on the basis of the road information acquired by the road information acquisition unit 20.

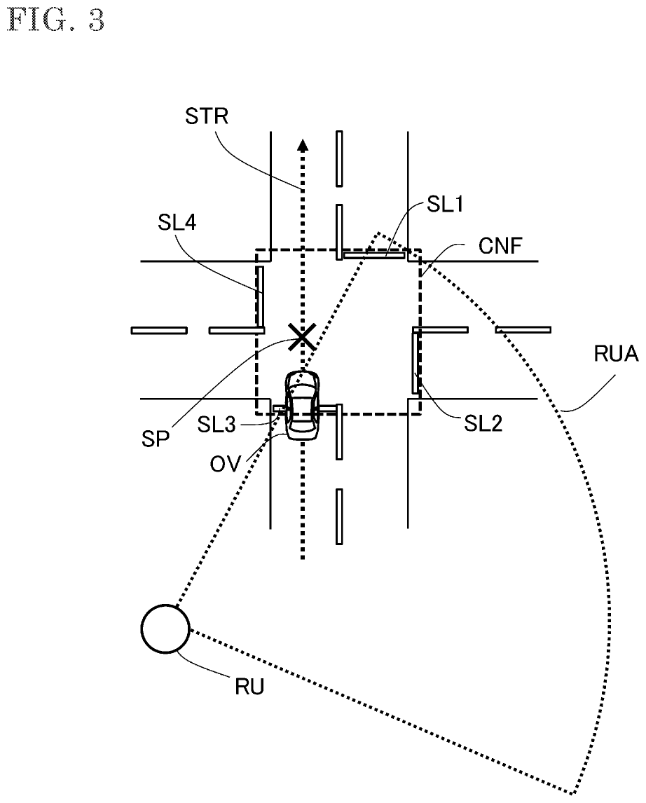

Next, an example of a method for determining whether or not the own vehicle will stop in an area where another traffic participant is greatly influenced, will be described with reference to FIG. 3. FIG. 3 illustrates operation of the behavior planning device 100 according to the first embodiment. In FIG. 3, the own vehicle OV traveling on the left side is about to enter an intersection, and a rectangular area indicated by a broken line connecting stop lines SL1, SL2, SL3, SL4 of lanes forming the intersection is an intersection area CNF. Here, the inner side of the stop lines SL1, SL2, SL3, SL4 of the intersection, i.e., the inside of the area CNF is an area where another traffic participant is greatly influenced, i.e., an area where advancement of another traffic participant is obstructed. A roadside unit RU provided at a roadside can detect an obstacle in an area RUA indicated by a dotted-line sector shape.

First, position information of the stop lines SL1, SL2, SL3, SL4 forming the intersection is inputted from the road information acquisition unit 20 to the behavior plan generation unit 140. By connecting pieces of position information of the stop lines SL1, SL2, SL3, SL4, the area CNF represented by a rectangular shape CNF can be generated. Then, if the stop position of the own vehicle OV is present inside the area CNF, it is determined that the own vehicle OV will stop in the area where advancement of another traffic participant is obstructed.

Next, the stop position of the own vehicle OV is calculated.

Center line information of the lane on which the own vehicle travels is acquired from the road information acquisition unit 20. Here, this information is assumed to be a straight route STR of a target route to be followed by the own vehicle. Then, the stop position of the own vehicle OV is represented by a stop position SP on the straight route STR in FIG. 3. The stop position SP of the own vehicle OV is calculated using the deceleration of the own vehicle OV on the straight route STR.

In FIG. 3, the gravity center position of the own vehicle OV at a time of stoppage is represented by the position SP. If this position is present in the intersection area CNF, it is determined that the own vehicle OV will enter the area where another traffic participant is greatly influenced at a time of stoppage.

The stop position SP may be any position that allows the own vehicle OV to be identified, such as the front end position or the rear end position of the own vehicle OV. Regarding whether or not the stop position SP is present in the area CNF, a rectangular shape according to the size of the own vehicle OV (a simulated outer shape of the own vehicle) may be generated from the position thereof (stop position), and if a part of the rectangular shape is present inside the intersection area CNF, it may be determined that the own vehicle OV will enter the area where another traffic participant is greatly influenced at a time of stoppage of the own vehicle OV.

In the above description, as the area where advancement of another traffic participant is obstructed, the area CNF corresponding to the intersection area is generated on the basis of the position information of the stop lines of the intersection inputted from the road information acquisition unit 20. However, the present disclosure is not limited thereto. As the area where another traffic participant is greatly influenced, the area CNF may be inputted to the behavior plan generation unit 140 directly on the basis of information such as intersection information that the road information acquisition unit 20 has. As another example, using diverging start position information that the road information acquisition unit 20 has, an area including a diverging start position may be set as the area CNF. Thus, the area CNF may be set without limitation to the intersection area.

<Operations of Vehicle Control System 1000 and Behavior Planning Device 100>

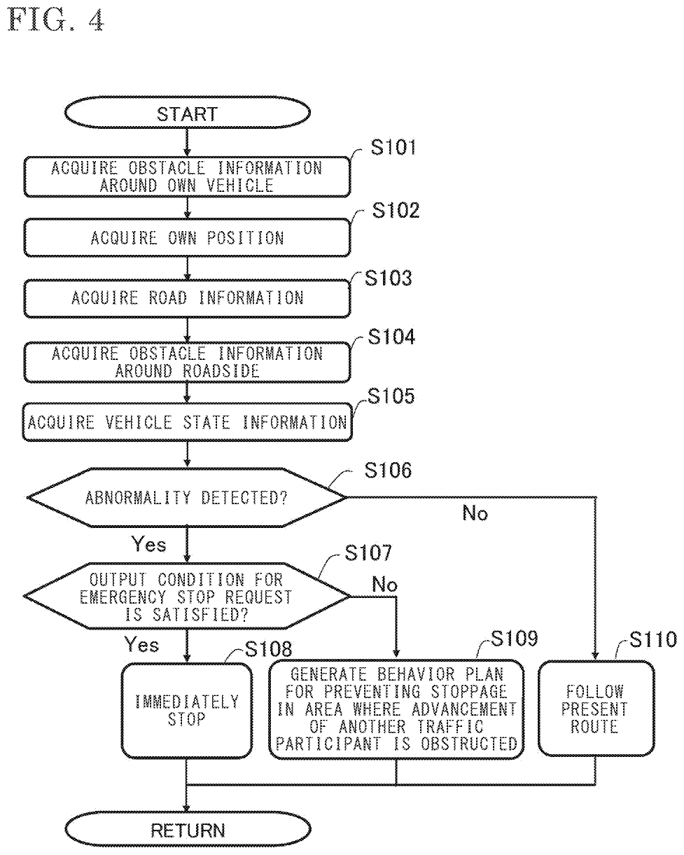

Next, operations of the vehicle control system 1000 and the behavior planning device 100 according to the first embodiment will be described with reference to a flowchart in FIG. 4. The process in the flowchart in FIG. 4 is repeatedly executed during traveling of the own vehicle. Steps in FIG. 4 will be described in association with the function units shown in the function block diagram in FIG. 1.

First, in step S101, the obstacle information acquisition unit 10 acquires information of an obstacle present around the own vehicle, outputted from the obstacle information detection unit 12.

In step S102, the own-position acquisition unit 30 acquires the own position outputted from the own-position detection unit 32.

In step S103, the road information acquisition unit acquires road information outputted from the road information detection unit (not shown) or road information of the map information acquisition unit.

In step S104, the roadside information acquisition unit 50 acquires obstacle information around the roadside outputted from the roadside unit RU.

In step S105, the vehicle state information acquisition unit 40 acquires information about the states of the vehicle from the sensors mounted to the vehicle and abnormality detection information from the vehicle abnormality detection unit 41.

In step S106, on the basis of the obstacle information around the own vehicle outputted from the obstacle information acquisition unit 10, the obstacle information around the roadside outputted from the roadside information acquisition unit 50, the road information acquired from the road information acquisition unit 20, the own-position information which is position information of the mobile object acquired from the own-position acquisition unit 30, and the vehicle state information acquired from the vehicle state information acquisition unit 40, the stop request determination unit 120 detects whether or not abnormality has occurred for any of the above information. When having detected abnormality, the stop request determination unit 120 outputs an emergency stop request or a stop request. If abnormality has been detected (Yes in step S106), the process proceeds to step S107. If abnormality has not been detected, an emergency stop request or a stop request is not outputted (No in step S106) and therefore the process proceeds to step S110.

If the process proceeds to step S107, the stop request determination unit 120 determines whether or not the output condition for an emergency stop request is satisfied. If the output condition for an emergency stop request is satisfied (Yes in step S107), the stop request determination unit 120 outputs an emergency stop request, thus proceeding to step S108. If the output condition for an emergency stop request is not satisfied (No in step S107), the stop request determination unit 120 outputs to a stop request, thus proceeding to step S109.

If the process proceeds to step S108, the behavior plan generation unit 140 performs output so as to immediately stop the own vehicle because the own vehicle cannot continue automated driving or the stop position of the own vehicle is in the area where advancement of another traffic participant is not obstructed.

If the process proceeds to step S109, the behavior plan generation unit 140 generates a behavior plan for preventing the own vehicle from stopping in the area where advancement of another traffic participant is obstructed.

If the process proceeds to step S110, the behavior plan generation unit 140 performs output so that the own vehicle continues to travel while following the route on which the own vehicle is traveling at present.

The output of the behavior plan generation unit 140 based on each of steps S108 to S110 is inputted to the vehicle control unit 200, which thus controls the actuators (not shown) for driving the vehicle, such as the brake and the steering wheel.

As described above, in the behavior planning device 100, when abnormality has occurred, if it is determined that the own vehicle needs to stop in emergency, a behavior plan for immediately stopping the own vehicle is generated, and otherwise, a behavior plan for preventing stoppage in the area where advancement of another traffic participant is obstructed is generated. In addition, if abnormality has not occurred, a behavior plan is generated so as to continue to travel while following the route on which the own vehicle is traveling at present.

As described above, according to the first embodiment, the behavior planning device includes the stop request determination unit and the behavior plan generation unit. The stop request determination unit detects abnormality on the basis of each acquired information. If abnormality is detected, the stop request determination unit determines whether or not the output condition for an emergency stop request is satisfied, and outputs an emergency stop request or a stop request for stopping in an area where advancement of another traffic participant is not obstructed, to the behavior plan generation unit. If an emergency stop request is outputted, the behavior plan generation unit generates a behavior plan for immediately stopping the own vehicle, and if a stop request is outputted, the behavior plan generation unit generates a behavior plan for stopping the own vehicle in the area where advancement of another traffic participant is not obstructed. Then, in accordance with the generated behavior plan, the vehicle control unit of the vehicle control system drives the actuators. Thus, determination is performed such that, in a case where the own vehicle cannot be prevented from stopping in an area where advancement of another traffic participant is obstructed even if the own vehicle continues to travel by automated driving or in a case where the own vehicle is in the area where advancement of another traffic participant is not obstructed even if the own vehicle stops at the present position, the own vehicle is immediately stopped, and otherwise, the own vehicle is stopped after being evacuated to the area where advancement of another traffic participant is not obstructed, whereby it is possible to prevent evacuation from being interrupted. This provides an effect of obtaining a behavior planning device and a vehicle control system that can reduce obstruction of advancement of another traffic participant.

### Second Embodiment

Hereinafter, a behavior planning device, a vehicle control system, and a behavior plan generation method according to the second embodiment of the present disclosure will be described with reference to the drawings.

The configurations of the behavior planning device and the vehicle control system according to the second embodiment are the same as those in FIG. 1 in the first embodiment, and description thereof is omitted.

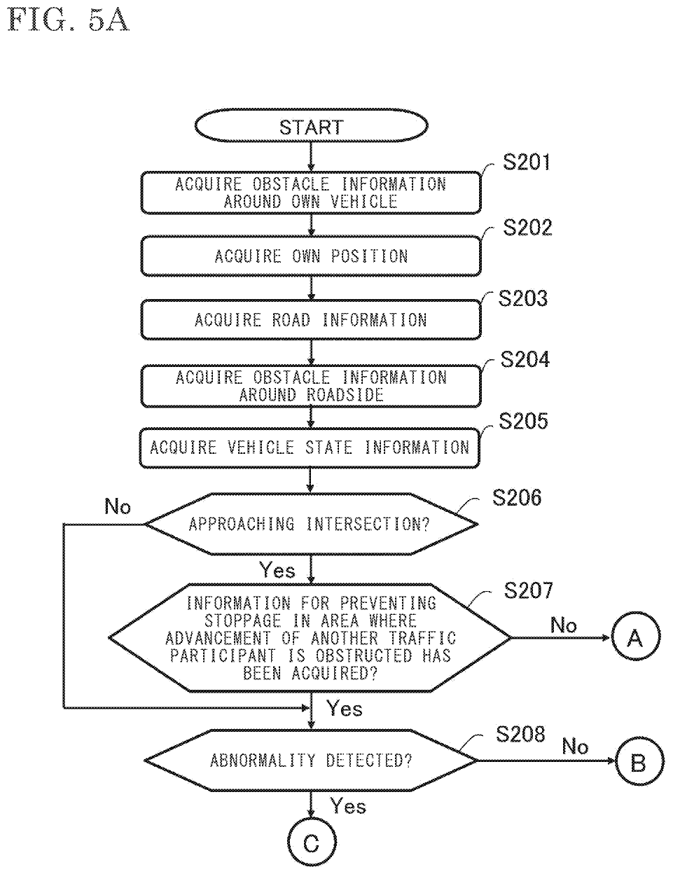

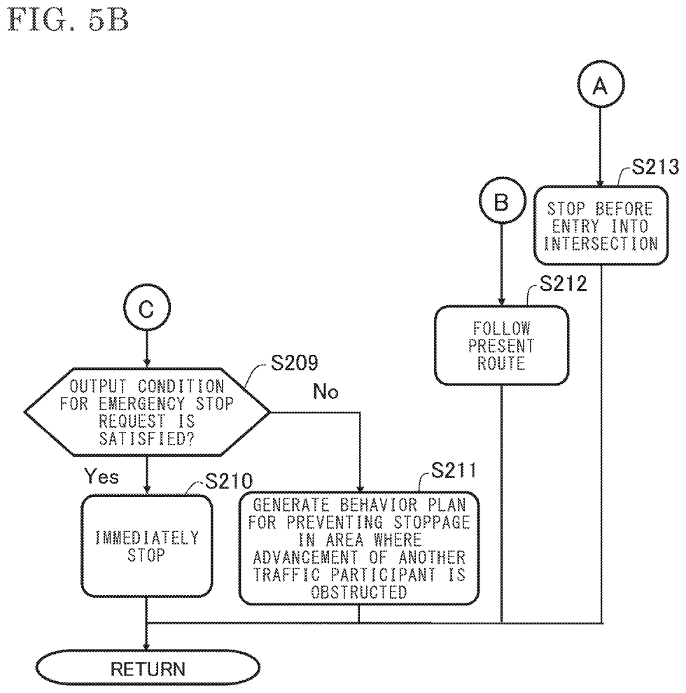

FIG. 5A and FIG. 5B are flowcharts showing operations of the vehicle control system 1000 and the behavior planning device 100 according to the second embodiment. The process in the flowcharts in FIG. 5A and FIG. 5B is repeatedly executed during traveling of the own vehicle. Steps in FIG. 5A and FIG. 5B will be described in association with the function units shown in the function block diagram in FIG. 1. Processing in steps S201 to S205 is the same as processing in steps S101 to S105 in FIG. 4 in the first embodiment, and therefore description thereof is omitted.

In steps S201 to S205, the vehicle control system 1000 acquires each information.

In step S206, the stop request determination unit 120 determines whether or not the own vehicle is approaching an intersection, on the basis of the own position outputted from the own-position acquisition unit 30 and the road information outputted from the road information acquisition unit 20. If it is determined that the own vehicle is approaching an intersection (Yes in step S206), the process proceeds to step S207. If it is determined that the own vehicle is not approaching an intersection (No in step S206), the process proceeds to step S208.

Here, whether or not the own vehicle is “approaching” may be determined through comparison with a predetermined threshold, e.g., in accordance with whether or not the distance between the entry-side stop line of the intersection and the own vehicle becomes a predetermined distance or less.

In step S207, the stop request determination unit 120 determines whether or not information for generating a behavior plan for preventing the own vehicle from stopping in the area where advancement of another traffic participant is obstructed has successfully been acquired. Specifically, the stop request determination unit 120 determines whether or not the own position, the vehicle state information, the road information, and the obstacle information for planning a behavior of the own vehicle leading to the outside of the area where advancement of another traffic participant is obstructed, have successfully been acquired. If necessary information has successfully been acquired (Yes in step S207), the process proceeds to step S208, and if necessary information has not successfully been acquired (No in step S207), the process proceeds to step S213.

In step S208, on the basis of the obstacle information around the own vehicle outputted from the obstacle information acquisition unit 10, the obstacle information around the roadside outputted from the roadside information acquisition unit 50, the road information acquired from the road information acquisition unit 20, the own-position information acquired from the own-position acquisition unit 30, and the vehicle state information acquired from the vehicle state information acquisition unit 40, the stop request determination unit 120 determines whether or not abnormality has occurred for any of the above information. If abnormality has occurred (Yes in step S208), the process proceeds to step S209. If abnormality has not occurred (No in step S208), the process proceeds to step S212.

In step S209, the stop request determination unit 120 determines whether or not the output condition for an emergency stop request is satisfied. If the output condition for an emergency stop request is satisfied (Yes in step S209), the process proceeds to step S210. If the output condition is not satisfied (No in step S209), the process proceeds to step S211.

If the process proceeds to step S210, the behavior plan generation unit 140 performs output so as to immediately stop the own vehicle because the own vehicle cannot continue automated driving or the stop position of the own vehicle is not in the area where advancement of another traffic participant is obstructed.

If the process proceeds to step S211, the behavior plan generation unit 140 generates a behavior plan for preventing the own vehicle from stopping in the area where advancement of another traffic participant is obstructed, and outputs the behavior plan.

If the process proceeds to step S212, the behavior plan generation unit 140 performs output so that the own vehicle continues to travel while following the route on which the own vehicle is traveling at present.

If the process proceeds to step S213, the stop request determination unit 120 performs output so as to make emergency stop before entry into the intersection, and the behavior plan generation unit 140 outputs a behavior plan so that the own vehicle stops before entry into the intersection.

That is, in the behavior planning device 100, before entry into the intersection, whether or not information for performing a behavior for preventing stoppage in the area where another traffic participant is greatly influenced has successfully been acquired is determined, and if the information has not successfully been acquired, a behavior plan for stopping before entry into the intersection is generated.

The output of the behavior plan generation unit 140 based on each of steps S210 to S213 is inputted to the vehicle control unit 200, which thus controls the actuators (not shown) for driving the vehicle, such as the brake and the steering wheel.

As described above, according to the second embodiment, the same effects as in the first embodiment are provided. That is, the second embodiment provides an effect of obtaining a behavior planning device and a vehicle control system that, in a case where abnormality has been detected on the basis of obstacle information, can prevent evacuation from being interrupted and can reduce obstruction of advancement of another traffic participant.

Further, before entry into an intersection, whether or not necessary information for a behavior for preventing stoppage in an area where advancement of another traffic participant is obstructed has been obtained, is determined, and if necessary information has not been obtained, the own vehicle is stopped before entry into the intersection. This provides an effect of obtaining a behavior planning device and a vehicle control system that can prevent evacuation from being interrupted in an intersection and can reduce obstruction of advancement of another traffic participant in an intersection.

### Third Embodiment

Hereinafter, a behavior planning device, a vehicle control system, and a behavior plan generation method according to the third embodiment of the present disclosure will be described with reference to the drawings.

The configurations of the behavior planning device and the vehicle control system according to the third embodiment are the same as those in FIG. 1 in the first embodiment, and description thereof is omitted.

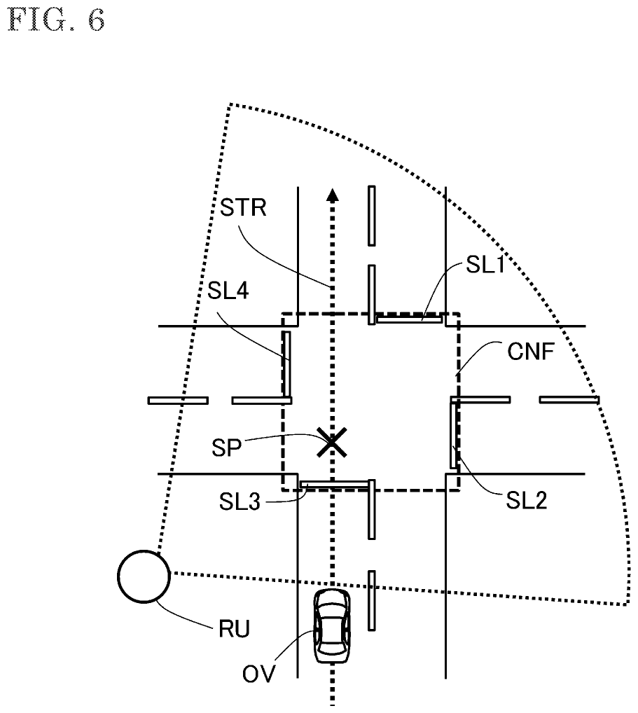

FIG. 6 illustrates operation of the behavior planning device 100 according to the third embodiment. In FIG. 6, the own vehicle OV traveling on the left side is approaching an intersection. A roadside unit RU provided at a roadside can detect an obstacle in an area RUA indicated by a dotted-line sector shape. Thus, road information in the intersection and obstacle information in the intersection can be detected.

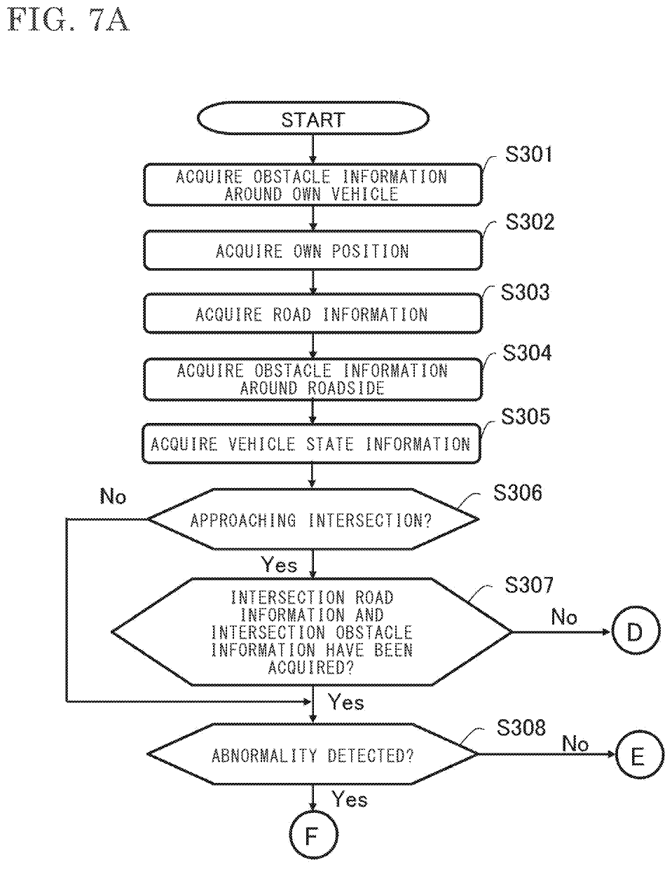

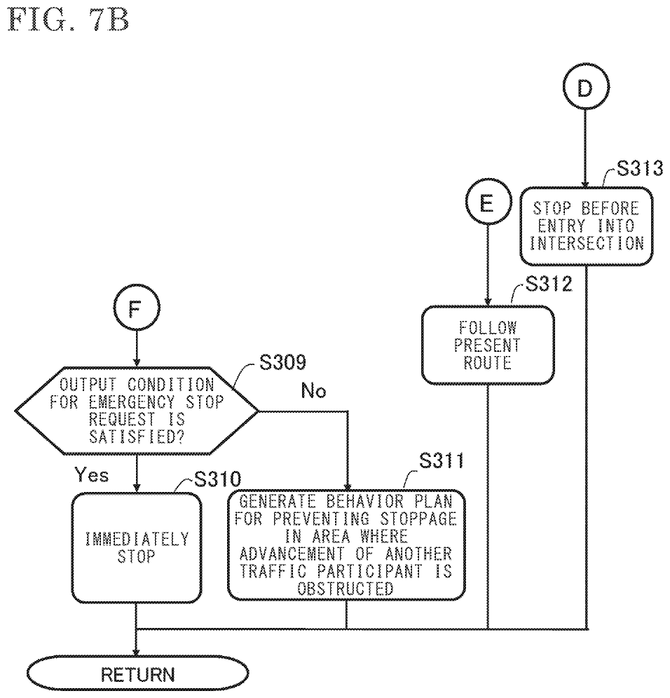

FIG. 7A and FIG. 7B are flowcharts showing operations of the vehicle control system 1000 and the behavior planning device 100 according to the third embodiment. The process in the flowcharts in FIG. 7A and FIG. 7B is repeatedly executed during traveling of the own vehicle. Steps in FIG. 7A and FIG. 7B will be described in association with the function units shown in the function block diagram in FIG. 1. Processing in steps S301, S302, and S305 is the same as processing in steps S101, S102, and S105 in FIG. 4 in the first embodiment. Further, processing in steps S306, S308, S309, S310, S311, S312, and S313 is respectively the same as processing in steps S206, S208, S209, S210, S211, S212, and S213 in the second embodiment. Therefore, description thereof is simplified below.

First, in step S301, the obstacle information acquisition unit 10 acquires information of an obstacle present around the own vehicle.

In step S302, the own-position acquisition unit 30 acquires the own position.

In step S303, the road information acquisition unit acquires road information outputted from the road information detection unit (not shown) or road information of the map information acquisition unit. Further, near an intersection, the road information acquisition unit 20 additionally acquires road information of the intersection sent from the roadside unit RU provided near the intersection or a remote traffic control system, i.e., intersection road information including passage permission information, construction information, traveling possible area information, or evacuation information at a time of occurrence of abnormality calculated by the roadside unit RU or the remote traffic control system, for example.

In step S304, the roadside information acquisition unit 50 acquires obstacle information around the roadside outputted from the roadside unit RU or the remote traffic control system. In addition, near an intersection, the roadside information acquisition unit 50 additionally acquires obstacle information near the intersection sent from the roadside unit RU provided near the intersection or the remote traffic control system, i.e., intersection obstacle information including an obstacle present on a crossing road and an obstacle at a blind spot for the own vehicle, for example.

In step S305, the vehicle state information acquisition unit 40 acquires abnormality detection information of the vehicle.

In step S306, the stop request determination unit 120 determines whether or not the own vehicle is approaching an intersection, on the basis of the own position outputted from the own-position acquisition unit 30 and the road information outputted from the road information acquisition unit 20. If it is determined that the own vehicle is approaching an intersection (Yes in step S306), the process proceeds to step S307. If it is determined that the own vehicle is not approaching an intersection (No in step S306), the process proceeds to step S308.

In step S307, whether or not the intersection road information has successfully been acquired in step S303 and whether or not the intersection obstacle information has successfully been acquired in step S304 are determined. If both kinds of information have successfully been acquired (Yes in step S307), the process proceeds to step S308. If both kinds of information have not successfully been acquired (No in step S307), the process proceeds to step S313. Also, if only either information has successfully been acquired, the process proceeds to step S313.

There is no problem if the intersection road information and the intersection obstacle information are successfully acquired from the roadside unit RU provided so as to have a detectable area RUA for the intersection as shown in FIG. 6. However, as shown in FIG. 3, in a case where the detection area covers only a part of the intersection or the roadside unit RU is not present near the intersection, both of the intersection road information and the intersection obstacle information might not successfully be acquired. Therefore, in step S307, if both kinds of information have not successfully been acquired (No in step S307), the process proceeds to step S313.

If the process proceeds to step S313, the stop request determination unit 120 outputs an emergency stop request before entry into the intersection, and the behavior plan generation unit 140 outputs a behavior plan so that the own vehicle stops before entry into the intersection.

That is, in the behavior planning device 100, when the own vehicle is approaching the intersection, the intersection road information and the intersection obstacle information are acquired in addition to information for a case of normal traveling, and if both kinds of information are not successfully acquired, a behavior plan for stopping before entry into the intersection is generated.

As described above, according to the third embodiment, the same effects as in the first embodiment are provided.

Further, when the own vehicle is approaching an intersection, intersection road information and intersection obstacle information are attempted to be acquired from a roadside unit provided near the intersection or a remote traffic control system, and if both of the intersection road information and the intersection obstacle information have not been obtained, the own vehicle is stopped before entry into the intersection. This provides an effect of obtaining a behavior planning device and a vehicle control system that can prevent evacuation from being interrupted in an intersection and can reduce obstruction of advancement of another traffic participant in an intersection. In addition, since information is acquired from a roadside unit, it is also possible to simplify sensors and a calculation device on the vehicle side.

The function units of the behavior planning device 100 according to each of the first to third embodiments may be implemented by a hardware configuration of the vehicle control system 1000 exemplified in FIG. 8, which is composed of a processing circuit 1001, a storage device 1002 including a read only memory (ROM) storing a program for executing the functions of the function units and a random access memory (RAM) storing data of execution results of the function units which are calculation results by the program, and an input/output circuit 1003. The input/output circuit 1003 receives output results about obstacle information from each obstacle information detection unit 12 which is the obstacle detection sensor provided to the own vehicle, output results about own-position information detected by the own-position detection unit 32 and obstacle information from the roadside unit RU, and the like. Then, control signals for the speed of the own vehicle, steering, and the like are outputted from the input/output circuit 1003 to drive-system equipment 2000 which includes the actuators for driving the vehicle, such as the brake and the steering wheel.

For the processing circuit 1001, a processor such as a central processing unit (CPU) or a digital signal processor (DSP) is used. Dedicated hardware may be used for the processing circuit 1001. In a case where the processing circuit 1001 is dedicated hardware, the processing circuit 1001 is, for example, a single circuit, a complex circuit, a programmed processor, a parallel-programmed processor, an application specific integrated circuit (ASIC), a field-programmable gate array (FPGA), or a combination thereof.

The function units of the behavior planning device 100 and the vehicle control system 1000 may be each implemented by an individual processing circuit, or may be collectively implemented by one processing circuit.

Regarding the function units of the behavior planning device 100 and the vehicle control system 1000, some of the functions may be implemented by a processing circuit as dedicated hardware, and other functions may be implemented by software, for example. Thus, the functions described above may be implemented by hardware, software, etc., or a combination thereof.

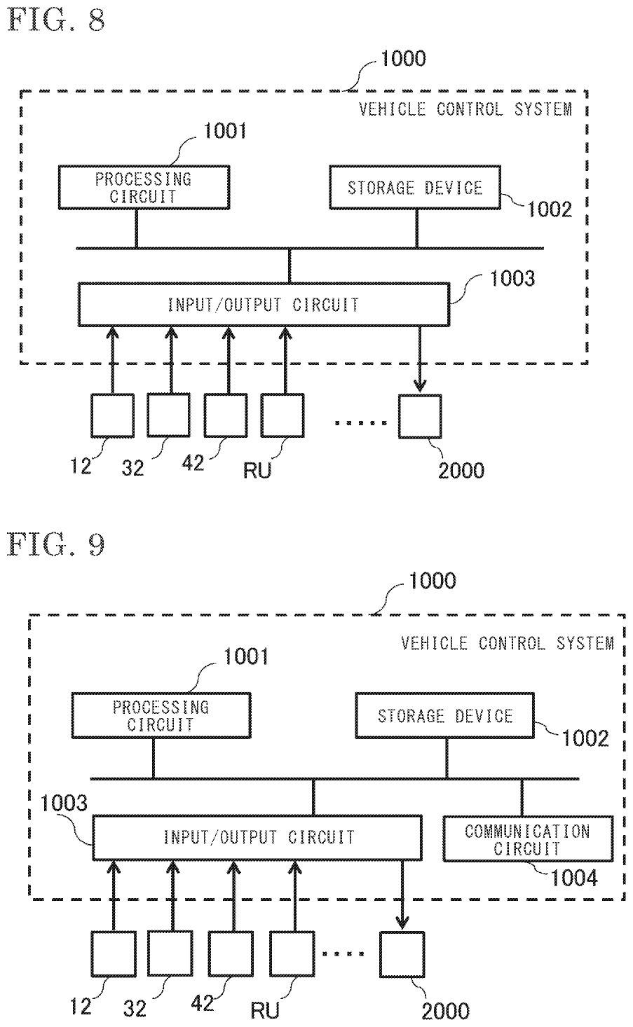

FIG. 9 shows another example of a hardware configuration of the vehicle control system 1000. A communication circuit 1004 is further provided in addition to the configuration in FIG. 8.

The communication circuit 1004 includes a long-range communication unit and a short-range communication unit as a communication module. As the long-range communication unit, the one compliant with a predetermined long-range wireless communication standard such as long term evolution (LTE) or fourth/fifth-generation mobile communication system (4G/5G) is used. For the short-range communication unit, for example, dedicated short range communications (DSRC) are used, and although not shown in the above embodiments, the short-range communication unit may be used for communication with another vehicle, whereby information of another vehicle around the own vehicle can be acquired. For these communications, certain communication speeds are ensured.

For example, in the third embodiment, intersection road information and intersection obstacle information may be acquired from another vehicle through vehicle-to-vehicle communication by short-range communication, or may be acquired from another information device provided near an intersection by short-range communication.

Obstacle information from the roadside unit RU or the remote traffic control system is received through communication by the vehicle control system 1000. For this communication, LTE or 5G is used, for example.

Each sensor of the obstacle information detection unit 12, the GNSS sensor of the own-position detection unit 32, and each sensor of the vehicle state detection unit 42 are mounted to the vehicle, and information from each sensor is outputted to the information acquisition unit 300 via a communication line. For example, they are connected using Controller Area Network (CAN) (registered trademark).

Also in a case where a part of the vehicle control system 1000 is present outside the own vehicle, e.g., in a traffic control system, and emergency stop is activated, transmission and reception of signals are performed by the communication circuit 1004.

### OTHER EMBODIMENTS

In the above description, the case where the mobile object to which the behavior planning device 100 and the vehicle control system 1000 are applied is an automobile which is a vehicle, has been shown as an example. However, the application target is not limited to an automobile, and may be other various movable bodies. The behavior planning device 100 can be used as a device for planning a behavior of a mobile object such as an in-building movable robot for inspecting the inside of a building, a line inspection robot, or a personal mobility, for example. In a case where the mobile object is other than an automobile, regarding detection information by the road information detection unit, a traveling possible area on a route for the mobile object to travel may be acquired as road information. As obstacle information acquired by the roadside unit RU, information from an obstacle information detection unit provided in a building, a line, or a range in which a personal mobility moves, for example, may be used.

In the above embodiments, dimensions, shapes, relative arrangement relationships, implementation conditions, or the like of constituent components may have been described, but they are merely examples in all aspects and are not limited to those described in the disclosure. Such features can be applied alone or in various combinations to one or more of the embodiments of the disclosure.

It is therefore understood that numerous modifications and equivalents which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

Unless there is no contradiction, a constituent component described as “one” component provided in the above embodiments may be provided as “one or more” components.

Each constituent component in the above embodiments is a conceptual unit, and the technical scope disclosed in the disclosure includes a case where one constituent component is formed of a plurality of parts, a case where one constituent component corresponds to a part of a structural body, and a plurality of constituent components are provided to one structural body.

Each constituent component in the above embodiments may be a part having another structure or shape, as long as the same function is exerted.

Descriptions in the disclosure are referred to for all purposes regarding the technical features disclosed here, and none of these are considered to be conventional art.

Each constituent component described in the above embodiments may be implemented as software or firmware, or as hardware corresponding thereto. In both concepts, each constituent component is referred to as “unit”, “processing circuit”, etc.

Hereinafter, modes of the present disclosure are summarized as additional notes.

(Additional Note 1)

A behavior planning device which receives obstacle information around a mobile object acquired by an obstacle information acquisition unit, position information of the mobile object acquired by an own-position acquisition unit, road information around the mobile object acquired by a road information acquisition unit, obstacle information around a roadside acquired by a roadside information acquisition unit, and vehicle state information including a control state of the mobile object acquired by a vehicle state information acquisition unit, the behavior planning device comprising:

a stop request determination unit which determines whether or not to output an emergency stop request for the mobile object, when having determined that abnormality has occurred for at least one of the obstacle information around the mobile object acquired by the obstacle information acquisition unit, the position information of the mobile object acquired by the own-position acquisition unit, the road information acquired by the road information acquisition unit, the obstacle information around the roadside acquired by the roadside information acquisition unit, and the vehicle state information acquired by the vehicle state information acquisition unit; and

a behavior plan generation unit which generates a behavior plan for the mobile object, wherein

the stop request determination unit, when having detected abnormality,
in a case where a predetermined output condition for the emergency stop request is satisfied, outputs the emergency stop request, and
in a case where the output condition is not satisfied, outputs a stop request, and

the behavior plan generation unit
in a case where the emergency stop request is outputted from the stop request determination unit, generates a behavior plan for immediately stopping the mobile object, and
in a case where the stop request is outputted from the stop request determination unit, generates a behavior plan for preventing the mobile object from stopping in an area where advancement of another traffic participant is obstructed.

(Additional Note 2)

The behavior planning device according to additional note 1, wherein

the stop request determination unit, when having determined that the abnormality has occurred,

in a case where it is impossible to prevent the mobile object from stopping in the area when the mobile object continues to travel, outputs the emergency stop request.

(Additional Note 3)

The behavior planning device according to additional note 1 or 2, wherein

the stop request determination unit, when having determined that the abnormality has occurred,

in a case where a position at which the mobile object will stop in emergency is in a stop permitted area included in the road information, outputs the emergency stop request.

(Additional Note 4)

The behavior planning device according to any one of additional notes 1 to 3, wherein

the stop request determination unit further determines whether or not the mobile object is approaching an intersection, and

in a case where the stop request determination unit has determined that the mobile object is approaching the intersection, if at least one of the obstacle information around the mobile object acquired by the obstacle information acquisition unit, the position information of the mobile object, the road information, the obstacle information around the roadside acquired by the roadside information acquisition unit, and the vehicle state information has not successfully been acquired,
the stop request determination unit outputs the emergency stop request, and
the behavior plan generation unit generates a behavior plan for stopping the mobile object before the mobile object enters the intersection.

(Additional Note 5)

The behavior planning device according to any one of additional notes 1 to 3, wherein

the stop request determination unit further determines whether or not the mobile object is approaching an intersection,

in a case where the stop request determination unit has determined that the mobile object is approaching the intersection, the stop request determination unit further acquires intersection road information from the road information acquisition unit and intersection obstacle information from the roadside information acquisition unit, and

if both of the intersection road information and the intersection obstacle information are not successfully acquired,
the stop request determination unit outputs the emergency stop request, and
the behavior plan generation unit generates a behavior plan for stopping the mobile object before the mobile object enters the intersection.

(Additional Note 6)

The behavior planning device according to any one of additional notes 1 to 5, further comprising the obstacle information acquisition unit, the own-position acquisition unit, the road information acquisition unit, the roadside information acquisition unit, and the vehicle state information acquisition unit.

(Additional Note 7)

A vehicle control system comprising:

the behavior planning device according to any one of additional notes 1 to 6; and

a vehicle control unit which controls the mobile object.

(Additional Note 8)

A behavior plan generation method executed using a behavior planning device, the method comprising:

a step of acquiring obstacle information around a mobile object;

a step of acquiring position information of the mobile object;

a step of acquiring road information around the mobile object;

a step of acquiring obstacle information around a road side;

a step of acquiring vehicle state information including a control state of the mobile object;

a step of determining whether or not abnormality has occurred for at least one of the obstacle information around the mobile object, the position information of the mobile object, the road information, the obstacle information around the roadside, and the vehicle state information that have been acquired;

a step of, when it is determined that the abnormality has occurred,
in a case where a predetermined output condition for the emergency stop request is satisfied, outputting the emergency stop request, and
in a case where the output condition is not satisfied, outputting a stop request;

a step of, in a case where the emergency stop request is outputted, generating a behavior plan for immediately stopping the mobile object; and

a step of, in a case where the stop request is outputted, generating a behavior plan for preventing the mobile object from stopping in an area where advancement of another traffic participant is obstructed.

(Additional Note 9)

The behavior plan generation method according to additional note 8, wherein

the predetermined output condition for the emergency stop request is that it is impossible to prevent the mobile object from stopping in the area when the mobile object continues to travel, and

when it is determined that the abnormality has occurred, in a case where it is impossible to prevent the mobile object from stopping in the area when the mobile object continues to travel, the emergency stop request is outputted.

(Additional Note 10)

The behavior plan generation method according to additional note 8 or 9, further comprising:

before the step of determining whether or not abnormality has occurred,

a step of determining whether or not the mobile object is approaching an intersection; and

a step of, in a case where it is determined that the mobile object is approaching the intersection, if at least one of the obstacle information around the mobile object, the position information of the mobile object, the road information, the obstacle information around the roadside, and the vehicle state information has not successfully been acquired, outputting the emergency stop request and generating a behavior plan for stopping the mobile object before the mobile object enters the intersection.

(Additional Note 11)

The behavior plan generation method according to additional note 8 or 9, further comprising:

before the step of determining whether or not abnormality has occurred,

a step of determining whether or not the mobile object is approaching an intersection;

a step of, in a case where it is determined that the mobile object is approaching the intersection, acquiring intersection road information from the road information and intersection obstacle information from the obstacle information around the roadside; and

a step of, in a case where both of the intersection road information and the intersection obstacle information are not successfully acquired, outputting the emergency stop request and generating the behavior plan for stopping the mobile object before the mobile object enters the intersection.

### DESCRIPTION OF THE REFERENCE CHARACTERS

10 obstacle information acquisition unit
12, 12a, 12b, 12c, 12d, 12e, 12f, 12g obstacle information detection unit
20 road information acquisition unit
30 own-position acquisition unit
32 own-position detection unit
40 vehicle state information acquisition unit
41 vehicle abnormality detection unit
42 vehicle state detection unit
50 roadside information acquisition unit
100 behavior planning device
120 stop request determination unit
140 behavior plan generation unit
200 vehicle control unit
300 information acquisition unit
1000 vehicle control system
1001 processing circuit
1002 storage device
1003 input/output circuit
1004 communication circuit
2000 drive-system equipment
OV own vehicle
RU roadside unit
RUA area
CNF area
SN1, SN2, SN3, SN4, SN5, SN6, SN7 detection range
SL1, SL2, SL3, SL4 stop line
SP stop position
STR straight route

What is claimed is:

1. A behavior planning device to receive obstacle information around a mobile object acquired by an obstacle information acquirer, position information of the mobile object acquired by an own-position acquirer, road information around the mobile object acquired by a road information acquirer, obstacle information around a roadside acquired by a roadside information acquirer, and vehicle state information including a control state of the mobile object acquired by a vehicle state information acquirer, the behavior planning device comprising:
a stop request determiner to determine whether or not to output an emergency stop request for the mobile object, when having determined that abnormality has occurred for at least one of the obstacle information around the mobile object acquired by the obstacle information acquirer, the position information of the mobile object acquired by the own-position acquirer, the road information acquired by the road information acquirer, the obstacle information around the roadside acquired by the roadside information acquirer, and the vehicle state information acquired by the vehicle state information acquirer; and
a behavior plan generator to generate a behavior plan for the mobile object, wherein
the stop request determiner, when having detected abnormality,
in a case where a predetermined output condition for the emergency stop request is satisfied, outputs the emergency stop request, and
in a case where the output condition is not satisfied, outputs a stop request, and
the behavior plan generator
in a case where the emergency stop request is outputted from the stop request determiner, generates a behavior plan for immediately stopping the mobile object, and
in a case where the stop request is outputted from the stop request determiner, generates a behavior plan for preventing the mobile object from stopping in an area where advancement of another traffic participant is obstructed.

2. The behavior planning device according to claim 1, wherein
the stop request determiner, when having determined that the abnormality has occurred,
in a case where it is impossible to prevent the mobile object from stopping in the area when the mobile object continues to travel, outputs the emergency stop request.

3. The behavior planning device according to claim 1, wherein
the stop request determiner, when having determined that the abnormality has occurred,
in a case where a position at which the mobile object will stop in emergency is in a stop permitted area included in the road information, outputs the emergency stop request.

4. The behavior planning device according to claim 1, wherein
the stop request determiner further determines whether or not the mobile object is approaching an intersection, and
in a case where the stop request determiner has determined that the mobile object is approaching the intersection, if at least one of the obstacle information around the mobile object acquired by the obstacle information acquirer, the position information of the mobile object, the road information, the obstacle information around the roadside acquired by the roadside information acquirer, and the vehicle state information has not successfully been acquired,
the stop request determiner outputs the emergency stop request, and
the behavior plan generator generates a behavior plan for stopping the mobile object before the mobile object enters the intersection.

5. The behavior planning device according to claim 1, wherein
the stop request determiner further determines whether or not the mobile object is approaching an intersection,
in a case where the stop request determiner has determined that the mobile object is approaching the intersection, the stop request determiner further acquires intersection road information from the road information acquirer and intersection obstacle information from the roadside information acquirer, and
if both of the intersection road information and the intersection obstacle information are not successfully acquired,
the stop request determiner outputs the emergency stop request, and
the behavior plan generator generates a behavior plan for stopping the mobile object before the mobile object enters the intersection.

6. The behavior planning device according to claim 1, further comprising the obstacle information acquirer, the own-position acquirer, the road information acquirer, the roadside information acquirer, and the vehicle state information acquirer.

7. A vehicle control system comprising:
the behavior planning device according to claim 1; and
a vehicle controller to control the mobile object.

8. A behavior plan generation method executed using a behavior planning device, the method comprising:
a step of acquiring obstacle information around a mobile object;
a step of acquiring position information of the mobile object;
a step of acquiring road information around the mobile object;
a step of acquiring obstacle information around a road side;
a step of acquiring vehicle state information including a control state of the mobile object;
a step of determining whether or not abnormality has occurred for at least one of the obstacle information around the mobile object, the position information of the mobile object, the road information, the obstacle information around the roadside, and the vehicle state information that have been acquired;
a step of, when it is determined that the abnormality has occurred,
in a case where a predetermined output condition for the emergency stop request is satisfied, outputting the emergency stop request, and
in a case where the output condition is not satisfied, outputting a stop request;
a step of, in a case where the emergency stop request is outputted, generating a behavior plan for immediately stopping the mobile object; and
a step of, in a case where the stop request is outputted, generating a behavior plan for preventing the mobile object from stopping in an area where advancement of another traffic participant is obstructed.

9. The behavior plan generation method according to claim 8, wherein
the predetermined output condition for the emergency stop request is that it is impossible to prevent the mobile object from stopping in the area when the mobile object continues to travel, and
when it is determined that the abnormality has occurred, in a case where it is impossible to prevent the mobile object from stopping in the area when the mobile object continues to travel, the emergency stop request is outputted.

10. The behavior plan generation method according to claim 8, further comprising:
before the step of determining whether or not abnormality has occurred,
a step of determining whether or not the mobile object is approaching an intersection; and
a step of, in a case where it is determined that the mobile object is approaching the intersection, if at least one of the obstacle information around the mobile object, the position information of the mobile object, the road information, the obstacle information around the roadside, and the vehicle state information has not successfully been acquired, outputting the emergency stop request and generating a behavior plan for stopping the mobile object before the mobile object enters the intersection.

11. The behavior plan generation method according to claim 8, further comprising:
before the step of determining whether or not abnormality has occurred,
a step of determining whether or not the mobile object is approaching an intersection;
a step of, in a case where it is determined that the mobile object is approaching the intersection, acquiring intersection road information from the road information and intersection obstacle information from the obstacle information around the roadside; and
a step of, in a case where both of the intersection road information and the intersection obstacle information are not successfully acquired, outputting the emergency stop request and generating the behavior plan for stopping the mobile object before the mobile object enters the intersection.

12. The behavior planning device according to claim 2, wherein
the stop request determiner, when having determined that the abnormality has occurred,
in a case where a position at which the mobile object will stop in emergency is in a stop permitted area included in the road information, outputs the emergency stop request.

13. The behavior planning device according to claim 2, wherein
the stop request determiner further determines whether or not the mobile object is approaching an intersection, and
in a case where the stop request determiner has determined that the mobile object is approaching the intersection, if at least one of the obstacle information around the mobile object acquired by the obstacle information acquirer, the position information of the mobile object, the road information, the obstacle information around the roadside acquired by the roadside information acquirer, and the vehicle state information has not successfully been acquired,
the stop request determiner outputs the emergency stop request, and
the behavior plan generator generates a behavior plan for stopping the mobile object before the mobile object enters the intersection.

14. The behavior planning device according to claim 3, wherein
the stop request determiner further determines whether or not the mobile object is approaching an intersection, and
in a case where the stop request determiner has determined that the mobile object is approaching the intersection, if at least one of the obstacle information around the mobile object acquired by the obstacle information acquirer, the position information of the mobile object, the road information, the obstacle information around the roadside acquired by the roadside information acquirer, and the vehicle state information has not successfully been acquired,
the stop request determiner outputs the emergency stop request, and
the behavior plan generator generates a behavior plan for stopping the mobile object before the mobile object enters the intersection.

15. The behavior planning device according to claim 2, wherein
the stop request determiner further determines whether or not the mobile object is approaching an intersection,
in a case where the stop request determiner has determined that the mobile object is approaching the intersection, the stop request determiner further acquires intersection road information from the road information acquirer and intersection obstacle information from the roadside information acquirer, and
if both of the intersection road information and the intersection obstacle information are not successfully acquired,
the stop request determiner outputs the emergency stop request, and
the behavior plan generator generates a behavior plan for stopping the mobile object before the mobile object enters the intersection.

16. The behavior planning device according to claim 3, wherein
the stop request determiner further determines whether or not the mobile object is approaching an intersection,
in a case where the stop request determiner has determined that the mobile object is approaching the intersection, the stop request determiner further acquires intersection road information from the road information acquirer and intersection obstacle information from the roadside information acquirer, and
if both of the intersection road information and the intersection obstacle information are not successfully acquired,
the stop request determiner outputs the emergency stop request, and
the behavior plan generator generates a behavior plan for stopping the mobile object before the mobile object enters the intersection.

17. A vehicle control system comprising:
the behavior planning device according to claim 2; and
a vehicle controller to control the mobile object.

18. A vehicle control system comprising:
the behavior planning device according to claim 3; and
a vehicle controller to control the mobile object.

19. The behavior plan generation method according to claim 9, further comprising:
before the step of determining whether or not abnormality has occurred,
a step of determining whether or not the mobile object is approaching an intersection; and
a step of, in a case where it is determined that the mobile object is approaching the intersection, if at least one of the obstacle information around the mobile object, the position information of the mobile object, the road information, the obstacle information around the roadside, and the vehicle state information has not successfully been acquired, outputting the emergency stop request and generating a behavior plan for stopping the mobile object before the mobile object enters the intersection.

20. The behavior plan generation method according to claim 9, further comprising:
before the step of determining whether or not abnormality has occurred,
a step of determining whether or not the mobile object is approaching an intersection;
a step of, in a case where it is determined that the mobile object is approaching the intersection, acquiring intersection road information from the road information and intersection obstacle information from the obstacle information around the roadside; and
a step of, in a case where both of the intersection road information and the intersection obstacle information are not successfully acquired, outputting the emergency stop request and generating the behavior plan for stopping the mobile object before the mobile object enters the intersection.
